(19) United States
(12) Patent Application Publication
(10) Pub. No.: US 2022/0030677 A1
(43) Pub. Date: Jan. 27, 2022

(54) METHOD FOR OPERATING A DOMESTIC COOKING APPLIANCE AND DOMESTIC COOKING APPLIANCE

(71) Applicant: BSH Hausgeräte GmbH, Munich (DE)

(72) Inventors: Markus Kuchler, Gstadt am Chiemsee (DE); Kerstin Rigorth, Mühldorf (DE); Sebastian Sterz, Großaitingen (DE)

(21) Appl. No.: 17/296,561

(22) PCT Filed: Dec. 6, 2019
(86) PCT No.: PCT/EP2019/084073

§ 371 Date: May 25, 2021

(30) Foreign Application Priority Data
Dec. 10, 2018 (DE) 10 2018 221 329.1

(51) Int. Cl. H05B 6/64; A23L 5/10; A47J 36/32

(52) U.S. Cl. CPC H05B 6/6447; A23L 5/15; A47J 2202/00; A23V 2002/00; A47J 36/32

(57) ABSTRACT

A domestic cooking appliance having a cooking space, a food treatment device for treating food located in the cooking space with several parameter configurations, and a sensor determining a measured value distributions of a surface property of the food. The food is cooked locally differently using at least two different parameter configurations, wherein the food treatment device is operated for a predetermined period of time with one parameter configuration, and a measured value distribution of the surface property is determined with the sensor after expiry of the period of time. A quality value is determined from the measured value distribution and, when the quality value, as determined by comparing at least two different scalar variables calculated from the same measured value distribution, does not meet a specified quality criterion, the food treatment device is operated with another parameter configuration.

The invention relates to a method for operating a household cooking appliance having a cooking chamber, at least one food treatment apparatus having parameter configurations for treating food located in the cooking chamber, it being possible for the food to be treated locally differently by means of at least two parameter configurations, and at least one sensor directed into the cooking chamber to determine measured-value distributions <V> of a surface property of the food, wherein, in the method, the at least one food treatment apparatus is operated for a predetermined time period with one of the parameter configurations in order to treat food located in the cooking chamber; following expiration of a time period, a measured-value distribution <V> of a surface property of the food is determined by means of the at least one sensor. The invention also relates to a household cooking appliance for performing the method. The invention is particularly advantageously applicable to microwave appliances.

US 2018/0098381 A1 and US 2017/0290095 disclose a computer-implemented method for heating an item in a cooking chamber of an electronic oven towards a target state. The method includes heating the item with a set of applications of energy to the cooking chamber while the electronic oven is in a defined configuration. The set of applications of energy and the configuration define a respective set of variable distributions of energy in the chamber. The method also includes capturing sensor data that defines a respective set of responses by the food to the set of applications of energy. The method also includes generating a plan to heat the item in the chamber. The plan is generated by a control system of the oven and uses the sensor data.

WO 2012/109634 A1 discloses an apparatus for processing objects with RF energy. The apparatus may include a display for displaying to a user an image of an object to be processed, the image including at least a first portion and a second portion of the object. The apparatus may also include an input unit and at least one processor configured to: receive information based on an input provided to the input unit, and generate, based on the received information, processing information for use in processing the object to achieve a first processing result in the first portion of the object and a second processing result in the second portion of the object.

The object of the present invention is to overcome the disadvantages of the prior art at least in part and in particular to provide a particularly easy-to-implement and effective means for treating food automatically in order to achieve a desired surface property.

This object is achieved in accordance with the features of the independent claims. Advantageous embodiments are the subject matter of the dependent claims, the description and the drawings.

The object is achieved in a method for operating a household cooking appliance having

a cooking chamber,

at least one food treatment apparatus having multiple parameter configurations for treating food located in the cooking chamber, it being possible for the food to be treated locally differently by means of at least two parameter configurations, and

at least one sensor directed into the cooking chamber to determine measured-value distributions <V> of a surface property of the food,

wherein, in the method,

the at least one food treatment apparatus is operated for a predetermined time period with one of the parameter configurations in order to treat food located in the cooking chamber,

following expiration of a time period, a measured-value distribution <V> of a surface property of the food is determined by means of the at least one sensor,

a quality value is determined from the measured-value distribution <V> and,

if the quality value does not meet a predetermined criterion (“quality criterion”), the food treatment apparatus is subsequently operated with another of the parameter configurations,

wherein

the quality value is determined from a comparison of at least two different scalar variables calculated from the same at least one measured-value distribution <V>.

This method provides the advantage that it can treat the food effectively and in a short time such that it achieves a desired surface property, in particular an even surface property.

In particular, the method enables targeted control of a property distribution on the surface of food using food-treating radiation (e.g. microwave radiation, thermal radiation, etc.) with the support of data from the at least one sensor. Intelligent control of a cooking appliance that can achieve an optimum cooking result dynamically and in relation only to a current time period or a current moment can in this way be achieved with little outlay. In particular, the associated computing outlay is low, so the method can be performed particularly quickly. Also, no memory is needed for storing large quantities of data. Targeted property patterns and property distributions can consequently also be set in conventional cooking appliances, and this can be done merely with the support of at least one simple sensor.

The surface property may, for example, be a temperature, moisture level or degree of browning measured on the surface of the food, but is not restricted to these. The distribution <V> is also referred to below as the “measured-value distribution” and represents a measured actual distribution of the food. Depending on the kind of surface property measured, it may then also be referred to as the temperature distribution, degree-of-browning distribution, etc. A desired target distribution of the surface property may be referred to as a target measured-value distribution or simply as a target distribution <Z>.

The parameter configurations {S_{q}} generally refer to a defined range of values which is given by the corresponding setting or operating parameters. A parameter configuration S_{q} corresponds in other words to a defined q^{th} set of setting or operating values of the household cooking appliance. A parameter configuration S_{q} comprises a setting value composed respectively of at least two possible setting values of at least one setting or operating parameter of the household cooking appliance. Each operating parameter may thus assume at least two values or states. In the simplest case, these two states may be “on” and “off”. The fact that at least two parameter configurations treat the food locally differently results in a different distribution of the surface property with a commensurate impact on the food by the two parameter configurations.

The scalar variables may, for example, comprise:

a minimum measured value of the measured-value distribution <V>,

a maximum measured value of the measured-value distribution <V>,

at least one average value of the measured-value distribution <V>,

a standard deviation of the average value and of the measured-value distribution <V>,

and links thereof, such as an additive or subtractive link, etc.

This provides the advantage that the scalar variables can be calculated or determined from precisely one measured-value distribution <V>.

The scalar variables may also include a change over time of these measured values, e.g. of the above scalar variables, for example a change over time of the minimum and/or maximum measured value, and of links thereof. In this case, the quality value can be determined from a comparison of two different scalar variables which are calculated from the same multiple measured-value distributions <V> recorded at different times.

It is a development that the scalar variables represent characteristic values for a central trend of the measured-value distribution <V>. This makes it possible to use a quality value that can be used in practice or is informative with little computing power.

It is an embodiment that the quality value is determined from a comparison of precisely two different scalar variables calculated from the same one measured-value distribution <V>, the two scalar variables being different average values or different types of average values with different calculation rules. This makes it possible to use a quality value that can be used in practice or is informative with particularly little computing power. The type of average value is not in principle restricted. Thus, the average values may, for example, include: a modal mean or mode as a measure of a variant with the highest frequency, a median value, an arithmetic mean, a geometric mean, a harmonic mean, a quadratic mean, a cubic mean. The average values may also, for example, include: a weighted mean (e.g. a weighted arithmetic mean, a weighted geometric mean, a weighted harmonic mean), a logarithmic mean, a winsorized and trimmed mean, a quartile mean, a mean of the shortest half, a Gastwirth-Cohen mean, moving averages, further generalized means such as a Holder mean, a Lehner mean, a Stolarsky mean, etc.

It is an embodiment that the two scalar variables comprise an arithmetic mean and a median value. The use of these two types of average values is particular easy to calculate and results in a quality value which can approximate a desired target distribution of the surface property of the food particularly well and effectively. Use of the comparison of arithmetic mean and median value is particularly advantageous where an even target distribution is to be achieved, as the arithmetic mean then equals the median. Consequently, approximation of the measured-value distribution <V> to the target distribution <Z> can be assessed by means of a simple comparison between arithmetic mean and median; the smaller the difference, the better the approximation. For an even distribution of the surface property, the underlying target values Zᵢ are the same, i.e. Zᵢ=const.

The average value Xₐᵣᵢₜₕₘ can be calculated from the k measured values Vᵢ (where i=1, . . . , k) on which a measured-value distribution <V> is based, for example according to

$${x}_{arithm} = \frac{1}{k} {\sum }_{i = 1}^{k} {V}_{i}$$

The median x_{med} can be calculated from the same measured-value distribution <V> for the sorted values Vᵢ, for example according to

$${x}_{m e d} = \{ \frac{{V}_{( \frac{k + 1}{2} )} for k uneven}{\frac{1}{2} ( {V}_{( \frac{k}{2} )} + {V}_{( \frac{k}{2} + 1 )} ) for k even}$$

It is an embodiment that the quality value comprises a difference of the two scalar variables, in particular an amount of the difference. This enables a particularly easy calculation and results in a quality value that can approximate a desired target distribution of the surface property of the food particularly well and effectively. The quality value Q can thus in particular be calculated according to

Q=|xₐᵣᵢₜₕₘ−x_{med}|

Particularly where an even target distribution of the surface property is desired, it has the advantageous property for implementing the method that it represents a natural measure of the approximation of the measured-value distribution <V> to a constant or even target distribution. When an even target distribution is reached, Q=0. This simplifies use of the quality value as a criterion for controlling the appliance considerably.

It is an embodiment that the quality criterion includes achievement of a predetermined threshold value (hereinafter referred to without restriction of generality as “quality threshold value”). This has the advantage of providing an easily implementable measure of when a conversion or switch should be made from a current parameter configuration to another parameter configuration in order to achieve a desired target distribution of the surface property of the food probably faster. If the quality value is defined as the amount difference between two average values, in particular the arithmetic mean and the median, the switch to the other parameter configuration may for example be made when the quality value is greater than the quality threshold value or in another variant is at least as great as the quality threshold value.

It is a development that the quality criterion includes achieving a predetermined quality threshold value, the threshold value corresponding to the quality value determined immediately beforehand (for example at the end of the previous time period Δt), optionally plus or minus a predetermined offset factor. This may also be worded such that the quality criterion includes where the currently determined quality value is less than a quality value determined immediately beforehand (for example at the end of the previous time period Δt), optionally plus or minus the offset factor. Compliance with the quality criterion consequently corresponds in particular to the case where, after treatment of the food during its last time period Δt, approximation to the target distribution <Z> was better than beforehand. This development has the advantage that a deterioration in the conformance of the surface property of the food with a desired target distribution can be reacted to particularly quickly and reliably. This can be implemented particularly easily and effectively if the quality value is defined or calculated as the amount difference between two average values, in particular the arithmetic mean and the median. It is a development that the quality threshold value is a fixed predetermined value. It can, however, also be a variable value which is dependent on e.g. at least one cooking parameter, at least one setting parameter and/or the type of food, etc.

If Qₚ designates, for example, the currently or most recently determined quality value and Qₚ₋₁ designates the quality value determined at the preceding time, then the quality criterion for retaining the parameter configuration in a development can also be described as

Qₚ<a·Qₚ₋₁ where a≤1 or as Qₚ≤a·Qₚ₋₁ where a<1

where a designates an offset factor and a·Qₚ₋₁ corresponds to the quality threshold value. The offset factor can be e.g. 1, 0.995, 0.99, 0.98, etc. The offset factor can be selected randomly, but then fixed, or it can be dynamically adapted. This development can generally also be described such that, if for the quality value Qₚ a sufficiently lower deviation from the target distribution <Z> occurs than for the quality value P_{q-1}, the method is continued with the current parameter configuration S_{q} being retained.

Instead of the offset factor, an additive offset can also be used. Use of the offset factor can advantageously prevent quasi-static states arising, in which only infinitesimal cooking progress occurs.

It is a development that the at least one sensor comprises at least one infrared sensor and/or at least one optical (sensitive in the visible spectrum) sensor. In this way, a surface quality can be determined particularly reliably and evaluated particularly effectively. The optical sensor is particularly suitable for determining a degree of browning and/or determining the moisture level on the surface of the food, while the infrared sensor is particularly suitable for determining a temperature distribution on the surface of the food. The infrared sensor is particularly sensitive in a near-infrared range (NIR).

It is therefore a development that, from the measured values of the at least one sensor, a spatially resolved, in particular pixel-type, measured-value distribution <V> of the surface quality of the food is prepared, in particular as a two-dimensional image. To this end, at least one sensor can be a sensor that makes spatially resolved measurements. This advantageously makes it possible for the method to be performed particularly quickly.

It is a development that the at least one optical sensor comprises or is a camera which records an image of the food that is composed in a pixel-type manner. The camera—in particular digital camera—is advantageously a color camera, but can also be a black-and-white camera. An appropriate measured value Vᵢ, e.g. of a degree of browning, is assigned to each of the pixels.

It is an embodiment that the at least one infrared sensor comprises at least one pixel-type measuring IR camera for recording at least one pixel-type thermal image (also referred to as a “thermal imaging camera”). An appropriate measured value Vᵢ in the form of a measured temperature value is assigned to each of the pixels. The measured surface property of the food is then its surface temperature.

Alternatively or additionally, at least one sensor can be moved relative to the food (e.g. by being fastened on a movable support) or at different spatial positions perform measurements which can be combined to form an overall image. This has the advantage that the surface, including in particular of voluminous food or of food that is not flat, can be captured or measured more fully. Alternatively or additionally, multiple sensors directed into the cooking chamber from different viewing angles and/or at different positions, whose measurements can be combined to form an overall image, can also be used. The at least one infrared sensor can then be fashioned for example as at least one thermopile, etc. The at least one infrared sensor can also be fashioned as an IR spectroscope.

Additionally or alternatively, the food can be moved in order for its surface property/ies to be measured. For example, the food can be placed on a turntable. Additionally or alternatively, the food in the cooking chamber can be height-adjustable, e.g. by means of a height-adjustable—in particular motorized—bracket for a food support or by means of a height-adjustable food support. The height of the food is adjusted in particular automatically by the household cooking appliance.

It is a development that the at least one sensor comprises at least one sensor directed into the cooking chamber for determining pixel-type measured-value distributions <V> on the food, and the scalar variables are calculated from the k individual pixels of the at least one, in particular precisely one, measured-value distribution <V>. The value of each pixel corresponds to a measured value Vᵢ. This has the advantage that the scalar variables can be determined particularly easily from the measured-value distribution <V>. A further advantage is that a measured-value distribution <V> typically consists of many pixels and thus of many measured values Vᵢ, and scalar variables, in particular average values, calculated from these are particularly robust.

The pixels can be used in their original resolution for performing the method, as a result of which the method can be performed particularly robustly. However, to reduce the computational outlay, the original resolution can also be reduced.

It is a possible embodiment thereof that the at least one sensor comprises at least one infrared sensor directed into the cooking chamber for determining pixel-type measured-value distributions <V> in the form of temperature distributions on the food, and the scalar variables are calculated from the individual pixels Vᵢ of the temperature distributions. However, the scalar variables can also be determined analogously from browning distributions, moisture distributions, etc.

It is an embodiment that the method is terminated if the quality value Q reaches a predetermined abort criterion and/or the food or its measured-value distribution <V> reaches a predetermined target value V_{target}. A particularly reliable approximation of the finished treated food to a desired target state can advantageously be achieved in this way. The abort criterion can be dependent in particular on the last recorded measured-value distribution <V>.

If the criterion includes the food reaching a predetermined target value V_{target}, this target value can be compared with the measured-value distribution <V>, but does not need to be. Thus, the criterion can, for example, also include reaching a cooking time, core temperature, etc. predetermined by the user or by the program.

It is an embodiment that the food has reached the predetermined target value V_{target} if max (<V>)≥V_{target} or min (<V>)≥V_{target} is met. In this way, various desired end states of the food can be achieved particularly reliably. The criterion max (<V>)≥V_{target} specifies for example that the method is to be terminated if even just one pixel has reached the target value V_{target}. Excessively powerful or lengthy treatment of the food can advantageously be prevented in this way. The criterion min(<V>)≥V_{target} specifies that the method is to be terminated when all the pixels have reached the target value V_{target}. Non-thorough treatment of the food can advantageously be prevented in this way.

It is an embodiment that the abort criterion comprises the achievement of—in particular achievement of or failure to achieve—a target quality value Q_{target}. Assuming that a measured-value distribution <V> is more closely approximated to the target distribution <Z>, the smaller Q is, the abort criterion can be met if e.g. Qₚ≤Q_{target}.

It is an embodiment that the at least one food treatment apparatus comprises at least one microwave apparatus for introducing microwaves into the cooking chamber, it being possible for different field distributions of microwaves in the cooking chamber to be generated by means of at least two parameter configurations S_{q} of the microwave apparatus.

The household cooking appliance can thus be a microwave appliance, the food treatment apparatus then having at least one microwave apparatus for introducing microwaves into the cooking chamber. The microwave apparatus comprises in particular at least one microwave generator (e.g. a magnetron, an inverter-controlled microwave generator, a solid-state microwave generator, etc.). For example, the operating frequency, and in the case of multiple microwave generators and/or infeed points, its relative phase, etc. can be used (especially where the generation of microwave power is semiconductor-based) as setting or operating parameters of the microwave generator which change a field distribution in the cooking chamber.

The microwave apparatus can furthermore have a microwave guide for guiding the microwaves generated by the microwave generator into the cooking chamber. The microwave guide can, for example, be or have a waveguide or an RF cable.

The microwave apparatus can furthermore have an adjustable field-changing component, i.e. a field distribution of the microwaves in the cooking chamber differs depending on the position of the field-changing component. Depending on the setting of the setting or operating parameters of these field-changing components, a certain field distribution and thus a certain heating pattern or change pattern will occur in the food.

The at least one field-changing component can have or be e.g. at least one rotatable antenna that decouples microwave energy into the cooking chamber, e.g. from the microwave guide. These rotary antennas are typically not rotationally symmetrical in shape, so an angular position can be specified for them as a setting or operating parameter which is selectively adjustable e.g. via a stepper motor. The at least one rotatable antenna can in a further development also be adjustable in terms of its height position.

The at least one field-changing component can additionally or alternatively have at least one microwave reflector that is adjustable in terms of its spatial position. The microwave reflector can be rotatable and/or movable. A rotatable microwave reflector can be fashioned as a wobbler. A movable microwave reflector can be fashioned as a spatially movable dielectric (made e.g. of Teflon).

In the event that the at least one food treatment apparatus has or comprises a microwave apparatus, the at least one setting or operating parameter can include at least one operating parameter from the group

respective angle of rotation of at least one rotatable antenna;

respective height position of at least one rotatable antenna;

spatial position of at least one microwave reflector;

microwave frequency;

relative phases between different microwave generators.

This does not rule out the possibility of setting further operating parameters of the microwave apparatus that can change the field distribution.

The household cooking appliance can, however, also be an oven, the food treatment apparatus then having at least one—in particular electrically operated—radiant heating element for introducing thermal radiation into the cooking chamber, e.g. at least one bottom-heat heating element, at least one top-heat heating element and/or at least one grill heating element.

It is a development that, in the case of an oven, the at least one food treatment unit comprises at least one food treatment unit from the group having

at least one electrical radiant heating element,

at least one induction coil,

at least one jet-directed cooling-air blower,

at least one jet-directed hot-air device and/or

at least one jet-directed water feed device.

This has the advantage that the surface property can be standardized with many devices (if present in the household cooking appliance) individually or in any combination or set to a different target distribution of the surface property. This in turn increases the effectiveness of the method. A jet-directed device can be understood to mean in particular a substance-introducing unit which is configured to introduce at least one locally limited directed flow of substance into the cooking chamber for local treatment of the food.

The purpose of the at least one electrical radiant heating element is to heat the cooking chamber or the food that is present in the cooking chamber through the emission of thermal radiation. It can be a respective tubular heating element, alternatively or additionally, for example, a printed conductor track, a resistance surface-heating element, etc. If the household cooking appliance is equipped with at least one electrical radiant heating element, the cooking chamber can also be referred to as an oven chamber.

The at least one radiant heating element can for example comprise at least one bottom-heat heating element for generating a bottom heat or bottom heating function, at least one top-heat heating element for generating a top heat or top heating function, at least one grill heating element for generating a grill function (optionally together with the at least one top-heat heating element), an annular heating element for generating hot air or a hot-air function, etc. The setting or operating parameter of a radiant heating element can in particular comprise different electrical powers or power levels, e.g. <0 W, 200 W, . . . , 800 W>.

It is an embodiment that the at least one electrical radiant heating element comprises at least two radiant heating elements and the parameter configuration comprises settings for at least two of the radiant heating elements. In other words, different power distributions which correspond to different sets of setting parameters of at least two radiant heating elements can be used for performing the method.

It is a development that the radiant heating elements can be operated singly or individually, irrespective of whether multiple radiant heating elements are operated together when a particular operating mode (e.g. grill mode) is selected. This has the advantage that power distributions particularly well matched to achieving a desired distribution of the surface property can be provided.

It is a development that the radiant heating elements can be activated (in particular only) as functional “operating mode” groups or heat types which are assigned to particular operating modes. In one variant, precisely one radiant heating element can be activated in at least one operating mode or precisely one radiant heating element can be assigned to this operating mode. In at least one other operating mode, at least two radiant heating elements are activated or at least two radiant heating elements are assigned to this other operating mode. The specified local power distributions can then be produced from the power inputs of radiant heating elements belonging to different operating modes.

The household cooking appliance can also be a combination of oven and microwave appliance, e.g. an oven with additional microwave functionality or a microwave appliance with additional oven function, the combination appliance then having at least one microwave apparatus and at least one radiant heating element.

It is an embodiment that, in order to determine the measured-value distribution <V> of the food, its measured-value distribution <V> is isolated in an image, in particular a thermal image, recorded from the cooking chamber by means of the at least one sensor, i.e. only the measured-value distribution of food is considered for the method, while the surface property of the surroundings of the food (e.g. of a food support, of cooking chamber walls, etc.) is ignored or removed. In other words, measured values of the surface of the food are separated from measured values of other surfaces or image areas. In order to achieve this, an image recorded by the sensor can be subjected, for example, to image evaluation, in particular object recognition. This enables a particularly precise, automatic determination of the position of the food in the cooking chamber.

The surface of the food in the cooking chamber can alternatively or additionally be determined by evaluating thermal changes at the beginning of the cooking process. For example, the surface of the food will generally heat up more slowly than a typically metallic food support, which can be recognized and evaluated, for example, in a thermal image sequence. Alternatively or additionally, changes over time in the wavelength-dependent reflection can be evaluated.

Alternatively, the position of the food in the cooking chamber can be determined in another way, for example by the user. In one development, for example, an optical image of the cooking chamber can be recorded and made available to a user for viewing e.g. on a touch-sensitive screen, for example of the household cooking appliance and/or a user terminal device such as a smartphone or tablet PC. The user can now determine the image area that corresponds to the food. This can be done, for example, by tracing the contour of the food, recognized by the user, with a finger or pen on the touch-sensitive screen. Alternatively, the recorded image can be divided visually into sub-areas, and a user can select those sub-areas on which the food is shown, in particular on which the food is predominantly shown, in particular on which only the food is shown. The household cooking appliance can subsequently use only the sub-areas selected by the user to perform the method.

It is an embodiment that the method proceeds iteratively, in that

the at least one food treatment apparatus is operated in a p^{th} iteration step with p≥1, for the predetermined time period Δt with a q^{th} parameter configuration S_{q} with q≤p, in order to treat food located in the cooking chamber,

following expiration of the time period Δt, a p^{th} measured-value distribution <Vₚ> of the surface property of the food is determined by means of the at least one sensor,

the quality value Qₚ is calculated for the p^{th} measured-value distribution <Vₚ>,

if for the quality value Qₚ the specified quality criterion is met, the at least one food treatment apparatus is operated in a subsequent (p+1)^{th} iteration step with the same q^{th} parameter configuration S_{q}, and

if for the quality value Qₚ the specified quality criterion is not met, another parameter configuration S_{q+1} is set and the at least one food treatment apparatus is then operated in a subsequent (p+1)^{th} iteration step with the other parameter configuration S_{q+1}.

It is an embodiment that

at least one food treatment apparatus is operated in a p^{th} iteration step with p≥1 for the predetermined time period Δt with a q^{th} parameter configuration S_{q} with q≤p in order to treat food G located in the cooking chamber 2,

following expiration of the time period Δt, a p^{th} measured-value distribution <Vₚ> of the surface property of the food G is determined by means of the at least one sensor 9,

a change pattern <ES_{q}> is calculated from a comparison of the p^{th} measured-value distribution <Vₚ> with a (p−1)^{th} measured-value distribution <Vₚ₋₁> recorded before step a) and saved,

for all change patterns {<ES_{q}>} saved previously in the course of this method, a respective evaluation value B_{q} is calculated, which represents a difference between a deviation of a target distribution <Z> relative to the measured-value distribution <Vₚ> and a deviation of the target distribution <Z> relative to a prediction pattern <V′ₚ>, the prediction pattern <V′ₚ> representing an overlaying of the measured-value distribution <Vₚ> with the associated change pattern <ES_{q}>,

the particular parameter configuration S_{q} whose evaluation value B_{q} meets at least one predetermined criterion is set,

the quality value Qₚ is calculated for the p^{th} measured-value distribution <Vₚ>,

if for the quality value Qₚ the predetermined quality criterion is met, step a) is branched to iteratively while the current parameter configuration S_{q} is maintained, and

if for the quality value Qₚ the predetermined quality criterion is not met, the other parameter configuration S_{q+1} is set and the method then branches iteratively to step a).

The introduction of a prediction pattern and an evaluation value has the advantage that the desired target distribution can be approximated particularly effectively.

Step g) is executed in particular in the event that the p^{th} measured-value distribution <Vₚ> is better adapted to the target distribution <Z> than the previous, (p−1)^{th} measured-value distribution <Vₚ₋₁>, i.e. has caused an improvement in the actual distribution <V> toward achievement of the target distribution <Z>. Step h) is then executed in particular in the event that the p^{th} measured-value distribution <Vₚ> has not resulted in an improvement compared with the previous measured-value distribution <Vₚ₋₁>.

This method can thus include the measured-value distribution <Vₚ> possibly being even worse (or at least not sufficiently better) adapted to the target distribution <Z> than the previous measured-value distribution <Vₚ₋₁>, although for the underlying parameter configurations S_{q}, according to their evaluation value B_{q}, probably the best result of all previously set parameter configurations S_{q} was expected. Consequently, a new parameter configuration S_{q+1} that has not previously been used can now be selected and set. The stock of parameter configurations {S_{q}} for performing the method is thus gradually expanded as required. However, whether the new parameter configurations S_{q+1} actually result in a better measured-value distribution <Vₚ₊₁> than the measured-value distribution <Vₚ> is not known.

It is a further development that the other parameter configuration S_{q+1} is selectively predetermined or is selected randomly or pseudorandomly.

In particular, for homogeneous target distributions <Z>=const. or Zᵢ=const, ∀i can apply.

The change pattern <E(S_{q})> is a function of the measured-value distribution <Vₚ> recorded in the p^{th} iteration step and the measured-value distribution <Vₚ₋₁> recorded in the previous (p−1)^{th} iteration step, which can also be expressed as <E>=f(<Vₚ>, <Vₚ₋₁>), the measured-value distributions <Vₚ> and <Vₚ₋₁> in turn being based on the respective parameter configurations S_{q}, which can be the same or different. The comparison can in particular be a general difference.

In the event that the surface property is a temperature, the change pattern <E(S_{q})> maps the temperature rise that results with a certain parameter configuration S_{q} and can be determined by comparing the temperature distributions for the iteration steps (p−1) and p with one another.

In addition, for all change patterns {<E(S_{q})>} previously saved in the course of this method, a respective evaluation value B_{q} is calculated, which represents a difference between a deviation of a target distribution <Z> from the measured-value distribution <Vₚ> and a deviation of the target distribution <Z> from a prediction pattern <V′ₚ>, the prediction pattern <V′ₚ> representing an overlaying of the measured-value distribution <Vₚ> with the associated change pattern <E(S_{q})>. The prediction pattern <V′ₚ> corresponds to the measured-value distribution that would arise if the change pattern <E(S_{q})> were applied to <Vₚ>.

The evaluation value B_{q} in turn indicates how strongly applying the associated change pattern <E(S_{q})> in relation to the current measured-value distribution <Vₚ> is likely to approximate this measured-value distribution <Vₚ> to the target distribution <Z>. This has the advantage that an effect of a setting of the available parameter configurations S_{q} on the next iteration step can be estimated in a simple manner.

The fact that the parameter configuration S_{q}, the evaluation value B_{q} of which meets at least one predetermined criterion, is set means that exactly such an evaluation value B_{q} is produced, namely the evaluation value B_{q}, the application of which in the next iteration step is likely to achieve the best approximation to the target distribution <Z>.

In the event that the household cooking appliance has a microwave function, it is a development that

the at least one food treatment apparatus comprises a microwave apparatus (6) for introducing microwaves into the cooking chamber (G), it being possible for different field distributions of the microwaves in the cooking chamber (2) to be generated by at least two parameter configurations (S_{q}) of the microwave apparatus (6),

the surface property is a surface temperature of the food (G) and

the at least one sensor (9) comprises at least one infrared sensor (9) directed into the cooking chamber (2) for determining temperature distributions <V> on the food (G),

wherein, in the method

the microwave apparatus (6) is operated in a p^{th} iteration step with p≥1 for a predetermined time period (Δt) with a q^{th} parameter configuration (S_{q}) with q≤p in order to cook food (G) located in the cooking chamber (2) with microwaves,

following expiration of the time period (Δt), a p^{th} temperature distribution <Vₚ> of the food (G) is determined by means of the at least one infrared sensor (9)

from a comparison of the p^{th} temperature distribution <Vₚ> with a (p−1)^{th} temperature distribution <Vₚ₋₁> recorded before step a), a change pattern <E(S_{q})> is calculated and saved,

for all change patterns {<E(S_{q})>} previously saved in the course of this method, a respective evaluation value B_{q} is calculated, which represents a difference between a deviation of a target temperature distribution <Z> from the temperature distribution <Vₚ> and a deviation of the target temperature distribution <Z> from a prediction pattern <V′ₚ>, the prediction pattern <V′ₚ> representing an overlaying of the temperature distribution <Vₚ> with the associated change pattern <E(S_{q})>,

the parameter configuration (S_{q}), the evaluation value B_{q} of which meets at least one predetermined criterion, is set,

the quality value (Qₚ) is calculated for the p^{th} temperature distribution <Vₚ>,

if for the quality value Qₚ the predetermined quality criterion is met, the method branches iteratively to step a) while the current parameter configuration (S_{q}) is maintained, and

if for the quality value Qₚ the predetermined quality criterion is not met, the other parameter configuration (S_{q+1}) is set and the method branches iteratively to step a).

It is an embodiment that the change pattern <E(S_{q})> is calculated pixel-by-pixel as the difference between the p^{th} measured-value distribution <Vₚ> and the (p−1)^{th} distribution <Vₚ₋₁>, in particular according to

<E(S_{q})>=<Vₚ>−<Vₚ₋₁>

or in relation to an i^{th} pixel according to

E(S_{q})ᵢ=V_{p,i}−V_{(p-1),i}

The change pattern <E(S_{q})> represents the effect of a treatment of the food when the parameter configuration S_{q} is set. The change pattern <E(S_{q})> can also be referred to as the change distribution.

It is an embodiment that the evaluation value B_{q}=B(S_{q}) is calculated according to d)

B_{q}=Σ(|<Z*>−<Vₚ>|^{d}−|<Z*>−<V′ₚ>|^{d})

or, for i=1, k pixels, according to

$${B}_{q} = {\sum }_{i = 1}^{k} ( {\vert {Z}_{i}^{*} - {V}_{p , i} \vert}^{d} - {\vert {Z}_{i}^{*} - {V}_{p , i}^{′} \vert}^{d} )$$

wherein the prediction pattern <V′ₚ>, for example, can be calculated according to

<V′ₚ>=<Vₚ>+<E(S_{q})>

and the exponential factor d is predetermined. Hereinbelow, <E(S_{q})>, <V′ₚ> and <Vₚ> can have absolute temperatures as components and then are not in particular—e.g. normalized—relative distributions.

<Z*> denotes the target distribution which, based on the current measured-value distribution <Vₚ> and the derived arithmetic mean Xₐᵣᵢₜₕₘ of the k components of <Vₚ>, is aimed for as the momentary target state, taking temperature values into consideration. Xₐᵣᵢₜₕₘ is, in particular, a temperature specification in ° C. While the target distribution <Z> is dimensionless, <Z*> is given in ° C. Thus, the target distribution <Z*> can be defined component by component for all Z*ᵢ according to

Z*ᵢ=xₐᵣᵢₜₕₘ*Zᵢ

which can also be written as <Z*>=xₐᵣᵢₜₕₘ·<Z>. The exponential factor d indicates how strongly deviations from the target distribution <Z> should be taken into account. For d>1, the evaluation value B_{q} prefers heating patterns <E(S_{q})>, which compensate for large differences between the actual measured-value distribution <Vₚ> and the target distribution <Z>.

A normalized quality value Q_{p,norm} can also be introduced. This has the particular advantage that it is independent of absolute temperatures and is always in the range of values from 0 to 1. For this purpose, all k components Vᵢ are normalized from <Vₚ> to the maximum value V_{p,max}=max {Vₚᵢ}, whereby <V_{p_norm}> is determined component by component according to:

$${V}_{p\_norm , i} = \frac{{V}_{p , i}}{{V}_{max}}$$

Analogously, Q_{p_norm} can be defined according to:

$${Q}_{p\_norm} = \frac{1}{{V}_{p , max}} \frac{1}{k} {\sum }_{i = 1}^{k} {V}_{p , i}$$

Normalized and non-normalized values such as Q_{p_norm} and Qₚ can be used synonymously hereinbelow. In general, the method can be performed synonymously with normalized (in particular unitless) values or variables and with non-normalized values or variables.

Depending on the food to be treated, a custom choice of d can be advantageous. In particular, a distinction can in this way be made between food with a low heat capacity which heats up quickly (e.g. popcorn) and food with a higher heat capacity and a correspondingly slower response behavior (e.g. a larger roasting joint).

However, the prediction pattern <V′ₚ> can also be calculated in another way, for example through weighted addition of the change pattern <E(S_{q})> with the measurement value distribution <Vₚ>.

The object is also achieved in a household cooking appliance which is designed to perform the method as described above. The household cooking appliance can be embodied analogously to the method and has the same advantages.

It is an embodiment that at least one food treatment apparatus for treating food located in the cooking chamber with several parameter configurations, it being possible for the food to be treated locally differently by at least two parameter configurations, and has at least one sensor directed into the cooking chamber for determining distributions <V> of a surface property of the food and a data processing device for performing the method.

The above-described properties, features and advantages of this invention and the manner in which they are achieved can be more clearly understood with reference to the schematic description below of an exemplary embodiment which is explained in more detail with reference to the drawings.

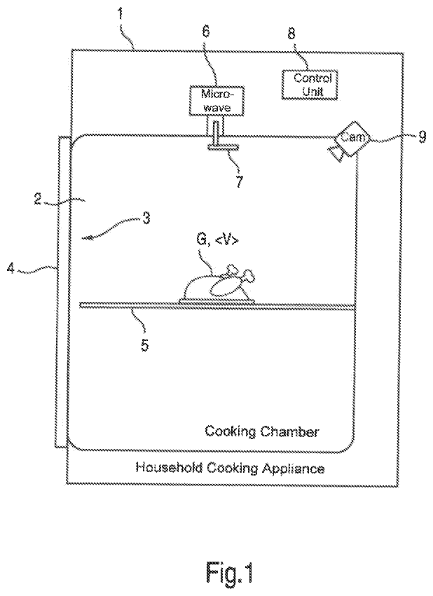

FIG. 1 shows a simplified outline of a household cooking appliance which is configured to perform the above-described method; and

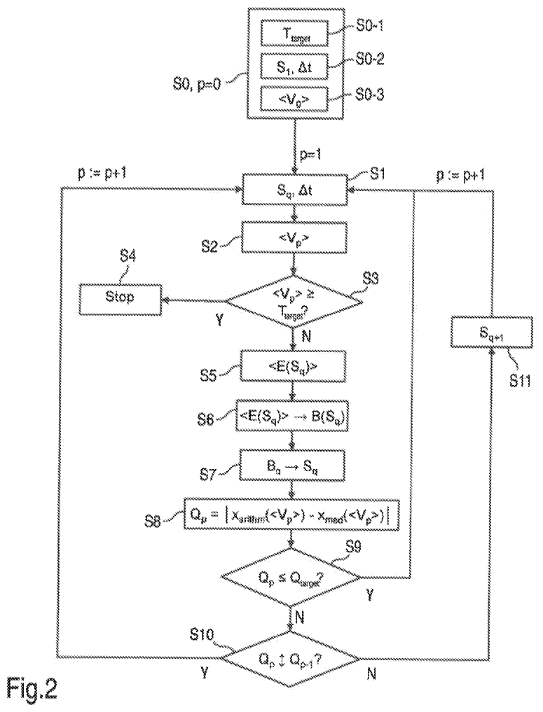

FIG. 2 shows various process steps of the above-described method.

FIG. 1 shows a sectional side view of an outline of a household cooking appliance in the form of a microwave appliance 1, which is configured to perform the method described in more detail in FIG. 2. The microwave appliance 1 has a cooking chamber 2 with a loading opening 3 on the front, which can be closed by means of a door 4. In the cooking chamber 2, food G is arranged on a food support 5.

The household cooking appliance 1 also has at least one food treatment unit in the form of a microwave generating apparatus 6. The microwave generating apparatus 6 can, for example, have an inverter-controlled microwave generator, a rotationally adjustable and/or height-adjustable rotary antenna 7 and/or a rotationally adjustable and/or height-adjustable wobbler (not shown). In addition, the microwave appliance 1 can have infrared radiant heating elements (not shown), for example a bottom-heat heating element, a top-heat heating element and/or a grill heating element.

The microwave generating apparatus 6 is controlled by means of a control unit 8. In particular, the microwave generating apparatus 6 can be set to at least two parameter configurations S_{q}, S_{q+1} with different field distributions in the cooking chamber 2. Different parameter configurations S_{q}, S_{q+1} can correspond, for example, to different angles of rotation of the rotary antenna 7. The angle of rotation thus corresponds to a field-varying setting or operating parameter of the microwave appliance 1 with at least two settings in the form of angle-of-rotation values.

The control unit 8 is also connected to an optical sensor in the form of a thermal imaging camera 9. The thermal imaging camera 9 is arranged such that it is directed into the cooking chamber 2 and can record a pixel-type thermal image of the food G. As a result, the thermal imaging camera 9 can be used to record or determine a temperature distribution <V> on the surface of the food G.

The control unit 8 can also be configured to perform the method described above and can also serve as an evaluation device for this purpose. Alternatively, the evaluation can be performed on an external instance such as a network computer or the so-called “cloud” (not shown).

FIG. 2 shows various process steps of the above-described method, which can run, for example, in the microwave appliance 1 described in FIG. 1. This method is designed as an iteration method, the number of iterations being indicated by the step or iteration index p.

After the food G has been introduced into the cooking chamber 2, the method is started, and an initial or starting step S0 is first performed for this purpose. An iteration index p=0 can be assigned to this starting step S0.

In a first sub-step S0-1 of the starting step S0, a target temperature T_{target} is set for the food G.

In a sub-step S0-2, a first parameter configuration S_{q}=S₁ is subsequently set for the rotary antenna 7, and the food G is then treated for a predetermined time Δt (for example, between 2 s and 15 s) by means of microwaves emitted by the microwave generating apparatus 6. The number of parameter configurations S_{q} previously set within the scope of the method is designated by the index q. Initially, therefore, q=1. The first parameter configuration S₁ can be predetermined or can be chosen randomly or pseudorandomly.

After the time period Δt has elapsed, an initial temperature distribution <Vₚ₌₀> of the food G is determined in a third sub-step S0-3 by means of the thermal camera.

The temperature distribution <Vₚ> of the food G is a segmental temperature distribution in that it has different sub-areas, each with uniform temperature values. For example, the image recorded by the thermal imaging camera can be divided into image segments of a certain edge length or a certain number of pixels. The value represented by a segment is a constant temperature value for this segment and can be determined, for example, by averaging the pixel values contained in the respective segment. In an extreme case, the segments correspond to individual pixels, i.e. the temperature distribution of the food used to perform the method is a pixel-by-pixel temperature distribution. In the following it is assumed as an example that the temperature distribution <Vₚ> of the food G is divided into k segments V_{p;i}, where i=1, k, i.e. <Vₚ>=<V_{p;1}; . . . ; V_{p;k}> applies.

In a method step S1, the microwave apparatus is operated for the predetermined time period Δt with a q^{th} parameter configuration S_{q}, where q≤p, in order to treat food G located in the cooking chamber with microwaves. If step S1 is run through for the first time after the starting step S0 or if step S1 immediately follows the starting step S0, then p=q=1. Since the parameter configuration S_{q} can be selected from a group of no more than p parameter configurations, then when step S1 is run through for the first time, initially only the parameter configuration S1 set in step S0-2 is available.

In a step S2, after the time period Δt has elapsed, a p^{th} temperature distribution <Vₚ> of the food G is determined by means of the thermal camera. The determination of the temperature distribution can comprise averaging of the temperature measurement values of individual pixels assigned to the respective segments V_{p;i}, if the segments V_{p;i} comprise more than one pixel.

In a simplified example with k=4 segments, the temperature distribution <Vₚ> in iteration step p can appear as follows:

$$〈 {V}_{p} 〉 = [ \begin{matrix}45 & 48 \\ 46 & 45\end{matrix} ]$$

wherein the individual temperature values V_{p,i} are given in degrees Celsius.

In a step S3, a query is made as to whether the temperature distribution <Vₚ> measured in step S2 has reached or exceeded the target temperature value T_{target}. If yes (“Y”), the method is terminated in a step S4. The condition or query in step S3 can generally be written as <Vₚ>≥T_{target} and in one example embodied as

max {V_{p,i}}≥T_{target}

i.e. the method is terminated if at least one segment V_{p,i} of the temperature distribution <Vₚ> has exceeded the target temperature. Alternatively, the method can be terminated, for example, if a certain number of segments V_{p,i}, a certain percentage of the segments V_{p,i} or all the segments V_{p,i} have reached or exceeded the target temperature value T_{target}. The latter condition can also be denoted as min {V_{p,i}}≥T_{target}.

If in the query performed in step S3 the condition is not met (“N”), the method branches to step S5.

In step S5, the previously measured p^{th} temperature distribution <Vₚ> is compared or linked to the previously measured temperature distribution <Vₚ₋₁> and from this a specific change pattern <E(S_{q})> for the currently set parameter configuration S_{q} is calculated, and this change pattern <E(S_{q})> is then saved. This can in particular be performed in such a way that the temperature distributions <Vₚ₋₁> and <Vₚ> are compared segment by segment, that is to say corresponding segments of the two temperature distributions <Vₚ₋₁> and <Vₚ> are linked to one another with the same index i.

Specifically, the change pattern <E(S_{q})> can be calculated as the difference between the two temperature distributions <Vₚ₋₁> and <Vₚ>, i.e. <E(S_{q})>=<Vₚ>−<Vₚ₋₁> is determined. The change pattern <E(S_{q})> is therefore also divided into k segments Eᵢ(S_{q}). In particular, segments V_{p;i} and V_{p-1;i} are subtracted from one another with the same index i, i.e. for all segments Eᵢ(S_{q}), the link

Eᵢ(S_{q})=Vₚ−Vₚ₋₁
a. is calculated. The change pattern <E(S_{q})> corresponds to a segment-by-segment distribution of the temperature differences between the two temporally consecutive temperature distributions <Vₚ₋₁> and <Vₚ> and thus substantively to an effect on the food G caused by this set parameter configuration S_{q}.

Based on the example above, for example if

$$〈 {V}_{p - 1} 〉 = [ \begin{matrix}44 & 42 \\ 44 & 43\end{matrix} ]$$

b. applies, a change pattern E_{q}=<E(S_{q})> is then given by

$${E}_{q} = [ \begin{matrix}45 & 48 \\ 46 & 45\end{matrix} ] - [ \begin{matrix}44 & 42 \\ 44 & 43\end{matrix} ] = [ \begin{matrix}1 & 6 \\ 2 & 2\end{matrix} ]$$

The change pattern <E(S_{q})> can be specified not only as a temperature difference, but also for example as a temperature increase per unit of time. In this case, the physical unit can be specified, for example, as ° C./s.

In a step S6, for all previously stored change patterns <E(S)>={<E(S_{q})>}, a respective evaluation value B(S_{q}) is calculated. When step S5 is run through for the first time, only the change pattern <E(S₁)> is available, so that only one evaluation value B(S₁) is then calculated.

The evaluation value B(S_{q}) is based here on a respective linking of the temperature distribution <Vₚ> and a prediction pattern <V′ₚ> to a target pattern <Z> for the food G. The prediction pattern <V′ₚ> corresponds to a segment-type temperature distribution, which corresponds to a temperature distribution approximated for the next iteration step, if the parameter configuration S_{q} were applied.

The prediction pattern <V′ₚ> can be calculated for a certain change pattern <E(S_{q})>, for example, segment by segment according to

<V′ₚ>=<Vₚ>+<E(S_{q})>
c. In the above example, the result would be

$$〈 {V}_{p}^{′} 〉 = [ \begin{matrix}46 & 54 \\ 48 & 47\end{matrix} ]$$

The evaluation value B(S_{q}) represents a degree or a measure of a probable deviation of the prediction pattern <V′ₚ> from a target pattern <Z> for the food G. The “best” calculation value B(S_{q}) indicates that if the microwave apparatus is set to the associated parameter configuration S_{q}, the target pattern <Z> is expected to be better approximated than with other previously set or trialed parameter configurations S_{q}. The evaluation value B_{q}=B(S_{q}) can also be referred to as “prediction quality”.

Specifically, the evaluation value B(S_{q}) can be calculated according to

B_{q}=Σ(|<Z*>−<Vₚ>|^{d}−|Z*>−<V′ₚ>|^{d})
d. which corresponds in segment-by-segment representation to the calculation

B_{q}=Σᵢ₌₁^{k}(|Z*ᵢ−Vₚ₋₁|^{d}−|Z*ᵢ−V′_{p,i}|^{d})
e. where k is the number of segments i. In this case, the greater the value of B_{q}, the better the target distribution <Z> is approximated.

The value of the exponent d is a preset value that determines how strongly deviations from the target distribution <Z> are taken into account. For d>1, it follows that the evaluation value B prefers change patterns <E(S_{q})> which compensate for large differences between the current temperature distribution <Vₚ> and the target distribution <Z>.

In the above example, if an even temperature distribution with T_{target}=80° C. is desired as the (normalized) target distribution <Z>, i.e.

$$〈 Z 〉 = [ \begin{matrix}1 & 1 \\ 1 & 1\end{matrix} ]$$

f. applies, such that with d=1 and an arithmetic mean Xₐᵣᵢₜₕₘ (<Vₚ>) where

$${x}_{arithm} = \frac{( 45 + 48 + 46 + 45 )}{4} ° C . = 46 ° C . \\ 〈 {Z}^{*} 〉 = [ \begin{matrix}46 & 46 \\ 46 & 46\end{matrix} ] ° C .$$

g. follows, and this results in an evaluation value

B(Sq)=(|1*46−45|−|1*46−46|)+(|1*46−48|—|1*46−54|)+(|1*46−46|−|1*46−48|)+(|1*46−45|−11*46−47|)=(1−0)+(2−8)+(0−2)+(1−1)=1−6−2+0=−7

For comparison, the evaluation value Bⱼ of another, older heating pattern <Eⱼ> is now determined with j<q:

$${E}_{j} = [ \begin{matrix}3 & 1 \\ 1 & 2\end{matrix} ]$$

$$B ( {S}_{j} ) = ( \vert 1 * 46 - 45 \vert - \vert 1 * 46 - 48 \vert ) + ( \vert 1 * 46 - 48 \vert - \vert 1 * 46 - 49 \vert ) + ( \vert 1 * 46 - 46 \vert - \vert 1 * 46 - 47 \vert ) + ( \vert 1 * 46 - 45 \vert - \vert 1 * 46 - 47 \vert ) = ( 1 - 2 ) + ( 2 - 3 ) + ( 0 - 1 ) + ( 1 - 1 ) == 1 - 1 - 1 + 0 = - 3$$

As a result, the change pattern <Eⱼ>≡=<E(Sⱼ)> would be selected, since B(Sⱼ)>B(S_{q}) holds. The comparison of the patterns <V′ₚ(E_{q})>, which results from applying <E_{q}>≡=<E(S_{q})>, and <V′ₚ(Eⱼ)>, which results from applying <E(Sⱼ)>, shows that the result <V′ₚ(Eⱼ)> is more even:

$$〈 {V}_{p}^{′} ( {E}_{q} ) 〉 = [ \begin{matrix}46 & 54 \\ 48 & 47\end{matrix} ] 〈 {V}_{p}^{′} ( {E}_{j} ) 〉 = [ \begin{matrix}48 & 49 \\ 48 & 47\end{matrix} ]$$

h. In a variant of the method, instead of

$${x}_{arithm} ( 〈 {V}_{p} 〉 ) = \frac{1}{k} {\sum }_{i = 1}^{k} {v}_{p , i}$$

i. an average value x′ₐᵣᵢₜₕₘ can be used, which already takes into consideration the expected heating when a change pattern <E(S_{q})> is applied, which can be represented in the form

$${x}_{arithm}^{′} ( 〈 {V}_{p} 〉 + 〈 E ( {S}_{q} ) 〉 ) = \frac{1}{k} {\sum }_{i = 1}^{k} ( {v}_{p , i} + {E}_{i} ( {S}_{q} ) )$$

xₐᵣᵢₜₕₘ and x′ₐᵣᵢₜₕₘ can be given in ° C.

In another variant, the average heating of a change pattern <E(S_{q})> can also be taken into consideration, especially in comparison to the average heating of the totality of all change patterns.

It is a development to exclude change patterns that do not have a certain minimum threshold in their average heating. This can prevent incorrect control of the method, since in the limit case <E(S_{q})>=<0> with
j.

$${V}_{p , i} = {V}_{p , i}^{′} and for$$

$${B}_{q} = {\sum }_{i = 1}^{k} ( {\vert {Z}_{i}^{*} - {V}_{p , i} \vert}^{d} - {\vert {Z}_{i}^{*} - {V}_{p , i}^{′} \vert}^{d} )$$

$$consequently {B}_{q} = 0 holds .$$

In a step S7, the parameter configuration S_{q} from the available group of parameter configurations {S_{q}} which have already been set at least once is set, which is likely to best approximate the target distribution <Z>. In particular, this can be the parameter configuration S_{q} that corresponds to the greatest evaluation value B(S_{q}).

In a step S8, for the p^{th} temperature distribution <Vₚ> an associated (p^{th}) scalar quality value Qₚ<Vₚ>, <Z>) is also calculated, which measures a deviation of the currently measured p^{th} temperature distribution <Vₚ> from the target distribution <Z> or represents a measure of the similarity of the currently measured p^{th} temperature distribution <Vₚ> to the target distribution <Z>. In the case here, for example, an even or homogeneous target distribution <Z> has been selected with <Z>=const., and the quality value Qₚ is a difference of the two scalar variables arithmetic mean xₐᵣᵢₜₕₘ and median value x_{med}, in particular an amount of the difference. This enables a particularly easy calculation and results in a quality value which can approximate a desired target distribution of the surface property of the food particularly closely and effectively. The quality value Q can consequently be calculated in particular according to

Qₚ=|xₐᵣᵢₜₕₘ(<Vₚ>)−x_{med}(<Vₚ>)|
k. where

$${Q}_{p} = \vert {x}_{arithm} ( < {V}_{p} > ) - {x}_{med} ( < {V}_{p} > ) \vert$$

$$k . where$$

$${x}_{arithm} ( < {V}_{p} > ) = \frac{1}{k} {\sum }_{i = 1}^{k} {V}_{p , i}$$

$$l . and where$$

$${x}_{m e d} ( 〈 {V}_{p} 〉 ) = \{ \frac{{V}_{p , ( \frac{k}{2} )} for k uneven}{\frac{1}{2} ( {V}_{p , ( \frac{k}{2} )} + {V}_{p , ( \frac{k}{2} + 1 )} ) for k even}$$

The smaller Qₚ, the closer xₐᵣᵢₜₕₘ generally is to x_{med} and thus <Vₚ> is to <Z>. Analogously, the normalized quality value Q_{p,norm} can also be used instead of Qₚ.

In this calculation step, in one variant, instead of the temperature distribution <Vₚ>, the temperature distribution <V*ₚ>, normalized to the maximum temperature value V_{p,max} of the segments V_{p,i}, with its segments V*_{p,i}=e.g. V_{p,i}/V_{p,max}, is used.

In step S9, which can also be optional, it is checked whether Qₚ<Q_{target} applies, i.e. whether the quality value Qₚ has reached a predetermined target value Q_{target}, i.e. whether the target distribution <Z> or <Z*> has been achieved sufficiently precisely. If yes (“Y”), the method branches back to step S1.

If the quality value Qₚ has not reached the quality value Q_{target} (“N”), the method branches to step S10.

In step S10, a query is made as to whether the quality value Qₚ is better or worse than the quality value Qₚ₋₁ calculated for the previous (p−1)^{th} step, which is symbolized by the expression “Qₚ [symbol] Qₚ₋₁?”. In particular, if the calculation rule

Qₚ=|xₐᵣᵢₜₕₘ(<Vₚ>)−x_{med}(<Vₚ>)|
m. is used, where

$${x}_{arithm} ( 〈 {V}_{p} 〉 ) = \frac{1}{k} {\sum }_{i = 1}^{k} {V}_{p , i}$$

n. and

$${x}_{med} ( < {V}_{p} > ) = \{ \frac{{v}_{p , ( \frac{k + 1}{2} )} for k uneven}{\frac{1}{2} ( {V}_{p , ( \frac{k}{2} )} + {V}_{p , ( \frac{k}{2} + 1 )} ) for k even}$$

o. the expression “Qₚ [symbol] Qₚ₋₁?” can be replaced by

Qₚ<a·Qₚ₋₁?
p. where a·Qₚ₋₁ corresponds to the quality threshold value and a≤1. In this way, it can in particular be achieved that the improvement in the quality value Qₚ compared to the quality value Qₚ₋₁ of the previous iteration must reach or exceed a certain minimum, in particular if a<1, e.g. where a=0.995. This can advantageously prevent quasi-static states occurring in which only an infinitesimal cooking progress occurs. The minimum a can be chosen randomly, but then it can be fixed, or it can be adjusted dynamically. If the quality value Qₚ is better than the quality value Qₚ₋₁ (“Y”), i.e. if in particular the condition Qₚ<a·Qₚ₋₁ is met, the method branches back to step S1, with the current parameter configuration S_{q} being maintained. In this case, the iteration index p is incremented by the value one according to p:=p+1. If, however, the condition is not met (“N”), the quality value Qₚ is therefore not better or is even worse than the quality value Qₚ₋₁, the method branches to step S11.

If in step S10 (“N”) (i.e. in particular Qₚ≥a·Qₚ₋₁ applies), a new parameter configuration S_{q+1} is set in a step S11 and the method then branches back to step S1. The iteration index p is incremented by one according to p:=p+1 (“iterative branching back”). The new parameter configuration S_{q+1} has not yet been set within the scope of the method. It can be predetermined or chosen randomly or pseudorandomly. This increases the number of group members of the group {S_{q}} of parameter configurations S_{q} by one.

The above-described method enables a targeted control of a heating distribution of food when using microwave or HF radiation with the aid of data from a thermal imaging camera. Intelligent control of a microwave cooking appliance, which can achieve a best possible cooking result dynamically and only in relation to the current moment, can be implemented with little outlay. Consequently, targeted temperature patterns and distributions can also be set in conventional microwave appliances, which was previously considered almost impossible—and this can be done merely with the aid of a simple thermal camera and a stepper motor for the rotary antenna.

Of course, the present invention is not limited to the exemplary embodiment shown.

Thus, the above method steps can also be performed in different sequences or, optionally, in parallel. For example, the sequence of steps S5 to S7 and S8 to S10 can be reversed, steps S3 and S4 can be performed immediately before or after step S8, etc.

Steps S7 and S8 can also already be performed for step p=1 if a quality value Q₀ is available, for example because it was calculated as part of the starting step S0.

In a further, also generally usable, modification, step S10 can be performed directly after step S7 (i.e. steps S8 and S9 are omitted). The quality evaluation can then be performed predictively in the form Qₚ=Qₚ (<Vₚ>+<E(S_{q})>, <Z>) even before the parameter configuration S_{q} is actually set.

It can also be taken into consideration that, due to the variability of the food and the overall system, it is possible that change patterns <E(S_{q})> determined in the past are no longer valid. It can then be generally advantageous if change patterns <E(S_{q})> that have no longer been used for a prolonged period (for example, upwards of a minute) are updated dynamically or are checked sporadically for their validity. This can be done, for example, by means of an intermediate step in which the microwave appliance 1 is set to the associated parameter configuration S_{q} and then, after treatment of the food with this parameter configuration S_{q}, the associated change pattern <E(S_{q})> is calculated and is saved in place of the old change pattern <E(S_{q})>.

Furthermore, the step sequence S3, S4 can be swapped with the step sequence S1, S2. The method then branches back to step S3 instead of step S1.

In addition, normalized or non-normalized values and variables can be used.

In general, the method can be performed with normalized or non-normalized values and distributions.

In general, “a”, “an” etc. can be understood to mean a singular or a plural, in particular in the sense of “at least one” or “one or more” etc., unless this is explicitly excluded, e.g. by the expression “exactly one” etc.

A numerical specification can also comprise precisely the specified number as well as a customary tolerance range, unless this is explicitly excluded.

### LIST OF REFERENCE CHARACTERS

1 Microwave appliance
2 Cooking chamber
3 Loading opening
4 Door
5 Food support
6 Microwave generating apparatus
7 Rotary antenna
8 Control unit
9 Thermal imaging camera
B(S_{q}) Evaluation value
<E(S_{q})> Change pattern
G Food
p Iteration step
Qₚ Quality value of the p^{th} iteration
Q_{target} Target quality value
S_{q} Parameter configuration
S1-S11 Method steps
T_{target} Target temperature
Δt Time period
<V> Temperature distribution on the surface of the food
<Vₚ> Temperature distribution in the p^{th} iteration
Xₐᵣᵢₜₕ Arithmetic mean
X_{med} Median value

1-17. (canceled)

18. A method for operating a household cooking appliance, said method comprising:
operating a food treatment apparatus of the household cooking appliance for a predetermined time period with one of the at least two parameter configurations,
treating food located in a cooking chamber of the food treatment apparatus locally differently by means of the at least two parameter configurations,
following an expiration of a time period, determining a measured-value distributions of a surface property of the food with a sensor directed into the cooking chamber,
determining a quality value by comparing at least two different scalar variables calculated from the measured-value distribution, and,
when the quality value does not meet a predetermined quality criterion, subsequently operating the food treatment apparatus with another of the at least two parameter configurations.

19. The method of claim 18, wherein the at least two different scalar variables are different mathematical average values.

20. The method of claim 19, wherein the at least two different scalar variables comprise an arithmetic mean and a median value.

21. The method of claim 18, wherein the quality value comprises a difference of the at least two different scalar variables.

22. The method of claim 21, wherein the quality value comprises an absolute value of the difference of the at least two different scalar variables.

23. The method of claim 22, wherein the predetermined quality criterion comprises reaching or falling below a predetermined quality threshold value.

24. The method of claim 18, wherein the sensor comprises a sensor directed into the cooking chamber, and further comprising determining a temperature distribution on the food pixel-by-pixel, and calculating the at least two different scalar variables from individual pixels of the measured-value distribution.

25. The method of claim 18, further comprising terminating the method when the quality value reaches a predetermined abort criterion, or when the measured-value distribution reaches a predetermined target value.

26. The method of claim 25, wherein the food has reached the predetermined target value when max (<Vₚ>)≥V_{target} or min (<Vₚ>)≥V_{target}, with (<Vₚ>) being the measured-value distribution and V_{target} being the predetermined target value.

27. The method of claim 18, wherein the food treatment apparatus comprises a microwave apparatus for introducing microwaves into the cooking chamber, and the at least two parameter configurations comprise different field distributions of the microwaves in the cooking chamber.

28. The method of claim 27, wherein the parameter configurations comprise each a value of an operating parameter of the microwave apparatus selected from the group
an angle of rotation of a rotatable antenna;
a height position of a rotatable antenna;
a spatial position of a microwave reflector;
a microwave frequency;
relative phases between different microwave generators.

29. The method of claim 18, wherein the method proceeds iteratively by
treating the food located in a cooking chamber in a p-th iteration step (p≥1) for the predetermined time period with a q-th parameter configuration (q≤p),
following the expiration of the time period, determining a p-th measured-value distribution of the surface property of the food with the sensor,
determining the quality value for the p-th measured-value distribution,
when the quality value meets the predetermined quality criterion, operating the food treatment apparatus a subsequent (p+1)-th iteration step with an unchanged q-th parameter configuration, and
when the quality value fails to meet the predetermined quality criterion, setting another of the at least two parameter configurations, and operating the food treatment apparatus in the subsequent (p+1)-th iteration step with the other of the at least two parameter configurations.

30. The method of claim 18, further comprising:
a) treating the food located in a cooking chamber in a p-th iteration step (p≥1) for the predetermined time period with a q-th parameter configuration (q≤p),
b) following the expiration of the time period, determining a p-th measured-value distribution of the surface property of the food with the sensor,
c) calculating a change pattern from a comparison of the p-th measured-value distribution with a (p−1)-th measured-value distribution recorded before step a) and saving the change pattern,
d) calculating an evaluation value for all previously saved change patterns, which represents a difference between a deviation of a target distribution from the measured-value distribution and a deviation of the target distribution from a prediction pattern, with the prediction pattern representing an overlay of the measured-value distribution with an associated change pattern,
e) setting the parameter configuration that has an evaluation value meeting a predetermined criterion,
f) calculating the quality value for the p-th measured-value distribution,
g) when the quality value meets the predetermined quality criterion, branching iteratively to step a) while retaining the current parameter configuration, and
h) when the quality value fails to meet the predetermined quality criterion, setting the other of the at least two parameter configurations, and then branching iteratively to step a).

31. The method of claim 30, wherein
the food treatment apparatus comprises a microwave apparatus for introducing microwaves into the cooking chamber, with the at least two parameter configurations generating different field distributions of the microwaves in the cooking chamber,
the surface property is a surface temperature of the food, and
the sensor comprises an infrared sensor or a thermal imaging camera directed into the cooking chamber.

32. The method of claim 30, wherein the change pattern (<E(S_{q})>) is calculated pixel-by-pixel as the difference between the p-th measured-value distribution (<Vₚ>) and the preceding (p−1)-th distribution (<Vₚ₋₁>) according to
<E(S_{q})>=<Vₚ>−<Vₚ₋₁>.

33. The method of claim 30, wherein the evaluation value (B_{q}) is calculated according to
B_{q}=Σ(|<Z*>−<Vₚ>|_{d}−|<Z*>−<V′ₚ>|^{d}),
wherein <Z*> is the target distribution, <Vₚ> is the p-th measured-value distribution, <V′ₚ> is the prediction pattern <V′ₚ>=<Vₚ>+<E(S_{q})> with (<E(S_{q})>) representing the change pattern, and d is an exponential factor.

34. The method of claim 18, further comprising determining the measured-value distribution of the food by isolating in an image recorded from the cooking chamber with the sensor.

35. A household cooking appliance, comprising
a cooking chamber;
a food treatment apparatus having at least two parameter configurations for treating food located in the cooking chamber;
a sensor directed into the cooking chamber to determine measured-value distributions of a surface property of the food; and
a control unit configured to:
operate the food treatment apparatus for a predetermined time period with one of the at least two parameter configurations,
treat the food located in a cooking chamber of the food treatment apparatus locally differently by means of the at least two parameter configurations,
following an expiration of a time period, determine a measured-value distributions of a surface property of the food with the sensor directed into the cooking chamber,
determine a quality value by comparing at least two different scalar variables calculated from the measured-value distribution, and,
when the quality value does not meet a predetermined quality criterion, subsequently operate the food treatment apparatus with another of the at least two parameter configurations.
